(19) United States
(12) Patent Application Publication
(10) Pub. No.: US 2011/0317728 A1
(43) Pub. Date: Dec. 29, 2011

(54) LASER SAFETY VIEWING WINDOW

(75) Inventors: Ashot Mesropyan, Fremont, CA (US); Michael Lloyd Watts, Union City, CA (US); Robert N. French, Chillicothe, OH (US); Donald A. Cline, Circleville, OH (US)

(73) Assignee: TELESIS TECHNOLOGIES, INC.,, Fremont, CA (US)

(21) Appl. No.: 12/825,358

(22) Filed: Jun. 29, 2010

(51) Int. Cl. H01S 3/13

(52) U.S. Cl. 372/29.015

(57) ABSTRACT

An apparatus includes a window to absorb and/or reflect a radiation of a laser light. The apparatus may include a continuous material affixed to the window to transfer energy through the continuous material in a continuous pattern such that an alteration of the continuous material from the laser light of a laser adjusts a power of the laser light of the laser. The window may be a transparent shield to allow a user to view the laser process and to protect the user from the radiation of the laser light. The continuous material may be a wire. The wire may be a string of a conductive material. Examples of the conductive material may include platinum, silver, iron, copper, aluminum, gold, brass, bronze, conductive plastic, and/or semiconductor. The alteration may be damage to the wire to interrupt the current of the electricity through the wire.

### FIELD OF TECHNOLOGY

This disclosure relates generally to laser safety technology and, more particularly, to a method, an apparatus and/or a system of providing safety through a laser viewing window.

### BACKGROUND

Lasers may pose certain safety risks to humans. Exposure to laser light may be harmful to human eyesight and human skin. Lasers may be operated in confined areas with protective barriers to shield humans from harm. The protective barrier may include a viewing window to allow a user to view the operation of the laser.

The viewing window may be designed to protect the user from the laser light by absorbing the radiation of laser light. There may be a limit to the amount of radiation the viewing window can absorb before the integrity of the viewing window is compromised. If the laser light of the laser is directed towards the viewing window, then the laser light may puncture the viewing window and escape the confined area. Laser light escaping the confined area may result in an injury to a human.

### SUMMARY

Disclosed are a method, an apparatus and/or a system of providing safety through a laser viewing window.

In one aspect, an apparatus includes a window to absorb and/or reflect a radiation of a laser light. The apparatus may include a continuous material affixed to the window to transfer energy through the continuous material in a continuous pattern such that an alteration of the continuous material from the laser light of a laser adjusts a power of the laser light of the laser. The window may be a transparent shield to allow a user to view the laser process and to protect the user from the radiation of the laser light. The continuous material may be a wire. The wire may be a string of a conductive material. Examples of the conductive material may include platinum, silver, iron, copper, aluminum, gold, brass, bronze, conductive plastic, a metal, a conductive composite material, a and/or semiconductor. The wire may conduct a current of electricity. The alteration may damage to the wire to interrupt the current of the electricity through the wire.

In another aspect, a system includes a workstation to enclose a laser light of a laser and to protect a user from a radiation of the laser light. The system may also include a window to view the laser light of the laser inside the workstation. The system may also include a continuous material affixed to the window to protect the user from the laser light, wherein the continuous material transfers energy through the continuous material in a continuous pattern such that an alteration of the continuous material from the laser light of the laser adjusts a power of the laser light of the laser.

In yet another aspect, a method includes affixing a continuous material to a window such that the continuous material is in a continuous pattern such that an alteration of the continuous material from a laser light of a laser adjusts a power of the laser light of the laser. The method also includes transferring energy through the continuous material. The method further includes determining an interruption of the energy through the continuous material and/or a change of a property of the continuous material (e.g., a change in a resistance of the continuous material). The method furthermore includes adjusting the power of the laser light of the laser based on the interruption of the energy through the continuous material. The method furthermore includes protecting the integrity of the window of a workstation such that the laser light of the laser remains confined within the workstation and the window prevents the laser light from exiting the workstation through the window based on an adjustment of the power of the laser light.

In addition, the method includes protecting the integrity of the window through a stoppage of the power of the laser light. The laser light may interrupt a flow of the energy through the continuous material and the laser light damages the continuous material. Furthermore, the method may also include determining a change in a resistance and/or another property (e.g., transparency, color, and/or temperature) of the continuous material. The method may further include stopping the power of the laser light based on the change in the resistance of the continuous material, and the laser light may change the resistance of the continuous material. Furthermore, the method may include increasing a level of a safety through the use of another window. The continuous material is affixed to the window such that the continuous material is affixed between the window and another window or the continuous material is affixed such that the window and the another window are adjacent to each other and the window is between the continuous material and the another window.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of an apparatus to provide safety through a laser viewing window, according to one or more embodiments.

FIGS. 2A-2B illustrate a process of construction of the apparatus of FIG. 1, according to one or more embodiments.

FIG. 3 is a system to provide safety through a laser viewing window, according to one or more embodiments.

FIG. 4A-4D is an example scenario of a laser experiment exemplifying working of the apparatus of FIG. 1 in a system of FIG. 3, according to one or more embodiments.

FIG. 5 is a schematic view of the apparatus of FIG. 1 including an additional window to provide safety through a laser viewing window, according to one or more embodiments.

FIG. 6 shows a process flow diagram detailing the operations involved in a method of providing laser safety through a window, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of providing laser safety though a window. Although the present embodiments have been described with reference to specific example embodiments, it will be evident that various modifications and changes may be made to these embodiments without departing from the broader spirit and scope of the various embodiments.

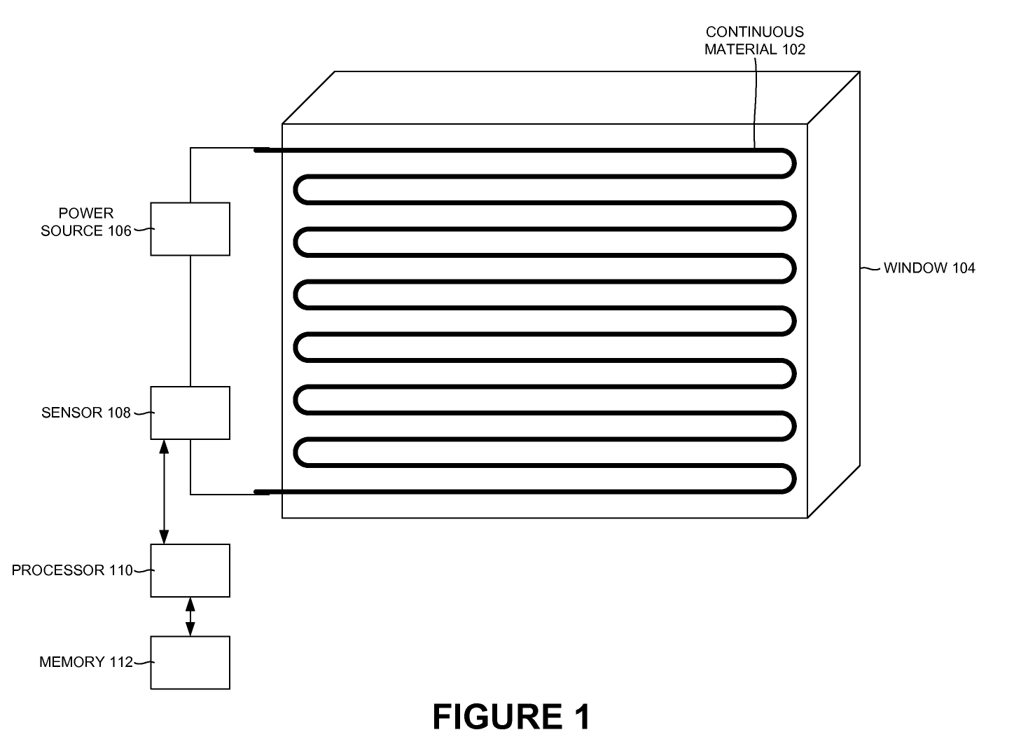

FIG. 1 is a schematic view of an apparatus to provide safety through a laser viewing window, according to one or more embodiments. In one or more embodiments, the apparatus may include a window 104 to absorb and/or reflect a radiation of a laser light. In one or more embodiments, the window 104 may be a transparent shield to allow a user to view the laser process through the window 104 while protecting the user from the radiation of the laser light. In one or more embodiments, the apparatus may also include a continuous material 102 affixed to the window 104 to transfer energy through the continuous material 102 in a continuous pattern such that an alteration of the continuous material 102 from the laser light of a laser adjusts a power of the laser light of the laser and/or shuts down the power of the laser light, such that the likelihood that laser light reaches the user is reduced and/or prevented. The alteration may be an interruption of a transfer of the energy through the continuous material, wherein the interruption is from a damage to the continuous material 102 from the laser light. In one or more embodiments, the continuous material 102 may be a wire. In one or more embodiments, the wire may be a string of a conductive material.

Examples of the conductive material may include, but is not limited to platinum, silver, iron, copper, aluminum, gold, brass, bronze, conductive plastic, metal, conductive composite material and semiconductor. In one or more embodiments, the wire conducts a current of electricity. In one or more embodiments, the alteration is damage to the wire to interrupt the current of the electricity through the wire.

In one or more embodiments, the continuous material 102 may be a conductive dry ink. In one or more embodiments, the conductive dry ink conducts a current of electricity. The alteration may be damage to the conductive dry ink, so as to interrupt the current of the electricity through the conductive dry ink.

In one or more embodiments, the continuous material 102 may be a conductive liquid. In one or more embodiments, the conductive liquid may be a liquid comprising a particle. For example, the conductive liquid may include water, salt, and/or any other conductive element. The conductive liquid may conduct a current of electricity and the alteration may be damage to the conductive liquid, so as to interrupt the current of the electricity through the conductive liquid. The conductive liquid may be a liquid that may be poured and stored within a grove in the window.

In one or more embodiments, the continuous material 102 may be an optical fiber. The optical fiber may include a core to propagate a light beam, a cladding to reflect the light beam back to the core, and a buffer coating to protect the core and the cladding. In the case of optical fibers constituting the continuous material 102, the alteration may cause damage to the optical fiber to interrupt a propagation of the light beam through the optical fiber.

The continuous pattern may be one of a switchback pattern, a zigzag pattern, a back-and-forth pattern, a grid pattern, a crisscrossing pattern, and any other pattern that covers a window such that the laser light that strikes the window may also strike the continuous material. The switchback may include a bend with an acute inner angle and a distance between the continuous material 102 before the bend and the continuous material 102 after the bend may be less than a diameter of the laser light.

In one or more embodiments, the apparatus may include a power source 106 coupled to the continuous material 102 to deliver energy through the continuous material 102. In one or more embodiments, the apparatus may further include a sensor 108 electrically connected between the power source 106 and the continuous material 102. The sensor 108 may determine an alteration of the continuous material such as an interruption of the delivery of energy through the continuous material and/or a change in a resistance and/or a temperature of the continuous material 102. The change in the resistance of the continuous material 102 indicates the alteration of the continuous material 102. The power of the laser light may be stopped based on the change in the resistance of the continuous material 102. The power of the laser light may be reduced when the continuous material 102 is damaged from the laser light.

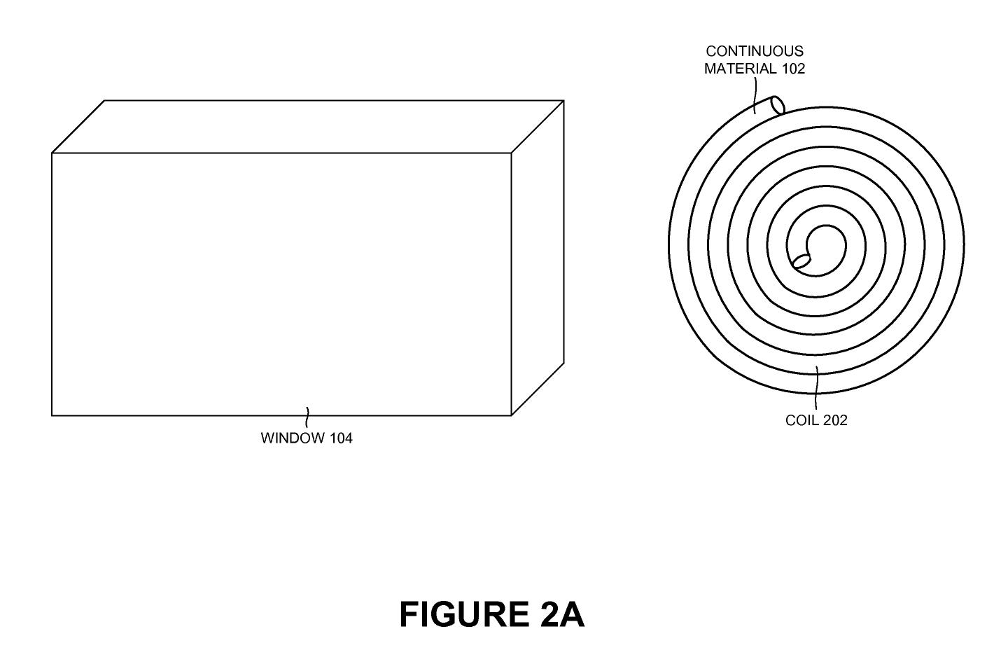

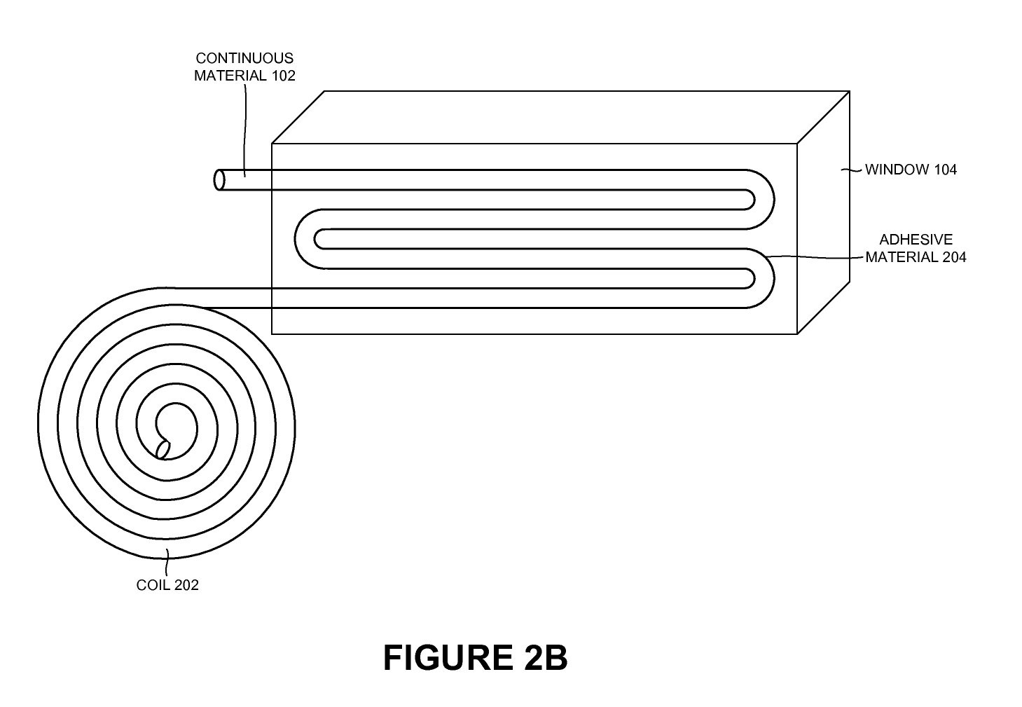

FIGS. 2A-2B illustrate a process of constructing the apparatus of FIG. 1. In one or more embodiments, a coil 202 of a continuous material 102 may be affixed to a window 104 to provide safety through the laser viewing window. The coil 202 may be affixed to the window 104 through an adhesive 204 in a predetermined position as illustrated in FIGS. 2A-2B. The affixation of the continuous material 102 may be through attaching the continuous material 102 to a surface of the window 104 and/or embedding the continuous material 102 within the window 104 such that the continuous material 102 is enclosed with the window 104. In one or more embodiments the continuous pattern may be a switchback pattern, a zigzag pattern, a back-and-forth pattern, a grid pattern and/or a crisscrossing pattern. The switchback may include a bend with an acute inner angle. A distance between the continuous material 102 before the bend and the continuous material 102 after the bend may be less than a diameter of the laser light.

In another embodiment, the window may have one or more holes along the sides of the window. The continuous material may be weaved through the holes of the window to form a continuous pattern. The diameter of a hole may be the same as the diameter of the continuous material to reduce the likelihood of the laser light escaping the workstation.

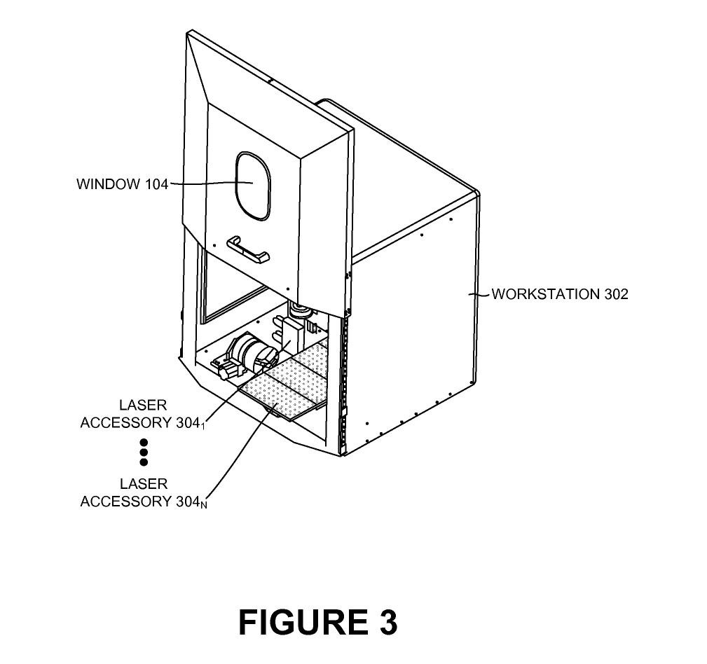

FIG. 3 is a system to provide laser safety, according to one or more embodiments. In one or more embodiments, the system may include a workstation 302 to enclose a laser light generated through laser equipment within the workstation 302. The workstation 302 may include one or more laser accessories (e.g., 304₁ to 304_{N}) used in the laser operation. In one or more embodiments, the system may also include a window 104 to view the laser light of the laser inside the workstation 302. In one or more embodiments, the system may further include a continuous material 102 affixed to the window 104 to protect the user from the laser light. The continuous material 102 may transfer energy through the continuous material 102 in a continuous pattern such that an alteration of the continuous material 102 from the laser light of the laser adjusts a power of the laser light of the laser.

In one or more embodiments, the alteration may decrease the power of the laser light. Additionally, the system may also include the laser equipment to generate the laser light such that the laser and the laser light are inside the workstation 302. Furthermore, the continuous material 102 may be affixed to the window 104 in the continuous pattern. In one or more embodiments, the continuous material 102 may be a wire. In one or more embodiments, the wire may be a string of a conductive material. Examples of the conductive material may include, but is not limited to, platinum, silver, iron, copper, aluminum, gold, brass, bronze, conductive plastic, metal, conductive composite and/or semiconductor. The wire may conduct a current of electricity. The alteration may be damage to the wire to interrupt the current of the electricity through the wire.

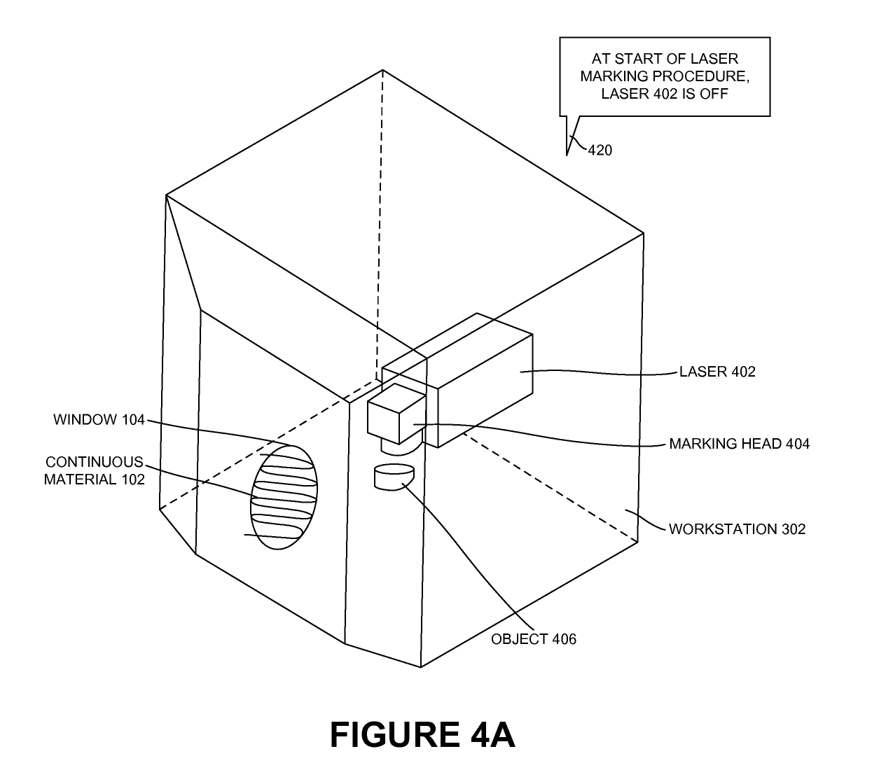

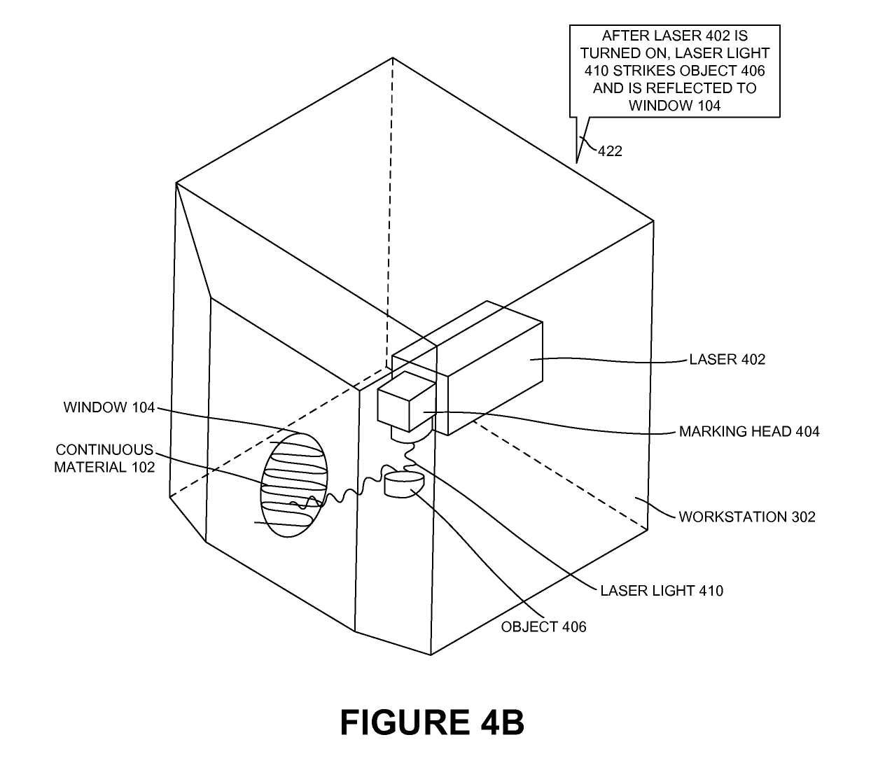

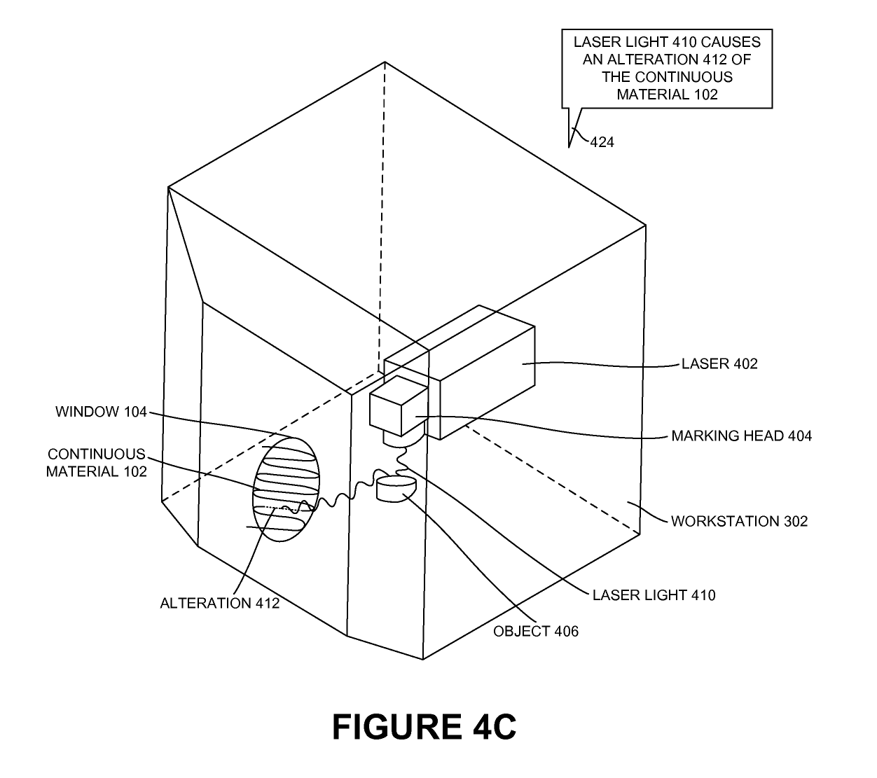

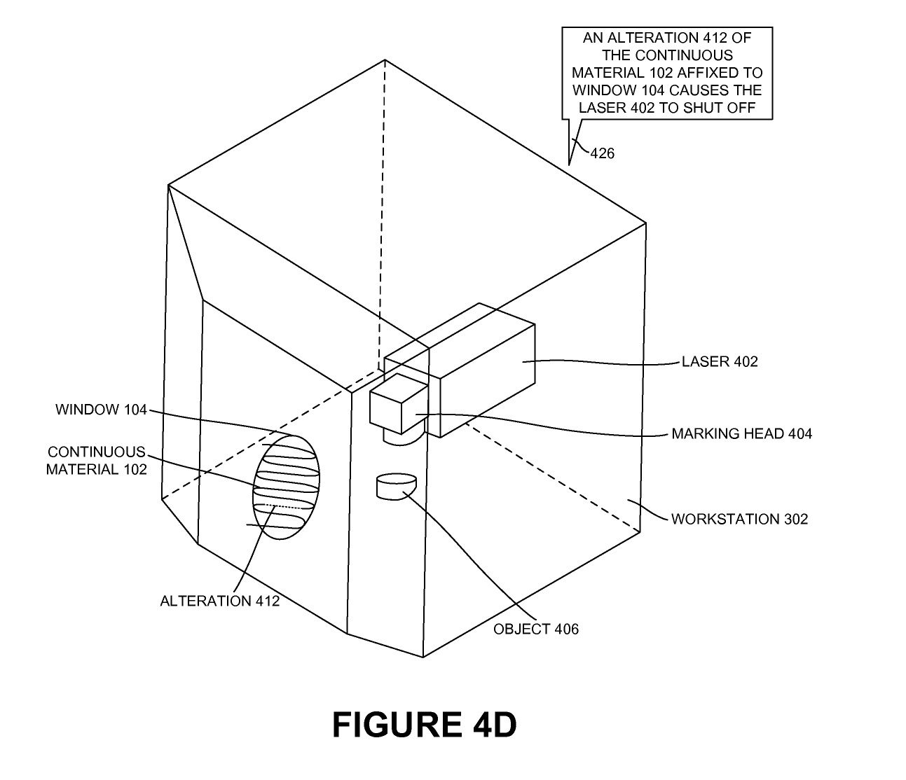

FIG. 4A-4D is an example scenario of a laser marking procedure exemplifying the working of the apparatus of FIG. 1 in a system of FIG. 3, according to one or more embodiments. FIG. 4A illustrates initiation of the laser experiment. During the initiation, a laser 402 may be OFF. A marking head 404 may be coupled to the laser 402 and may be directed toward and object 406 that may be designated for marking. When the laser is turned ON, a laser light 410 may strike the object 406. When the object is being marked, the laser light 410 may be reflected off the object and strike the window 104 as illustrated in FIG. 4B. The laser light 410 may strike the continuous material 102 and may cause a alteration of the continuous material 102 as illustrated in FIG. 4C. The alteration reduces the power of the laser light 410 and prevents transmission of the laser light through the continuous material to an environment outside the workstation 302, thereby protecting a user viewing the laser operation from outside the window, from the laser light as illustrated in FIG. 4D.

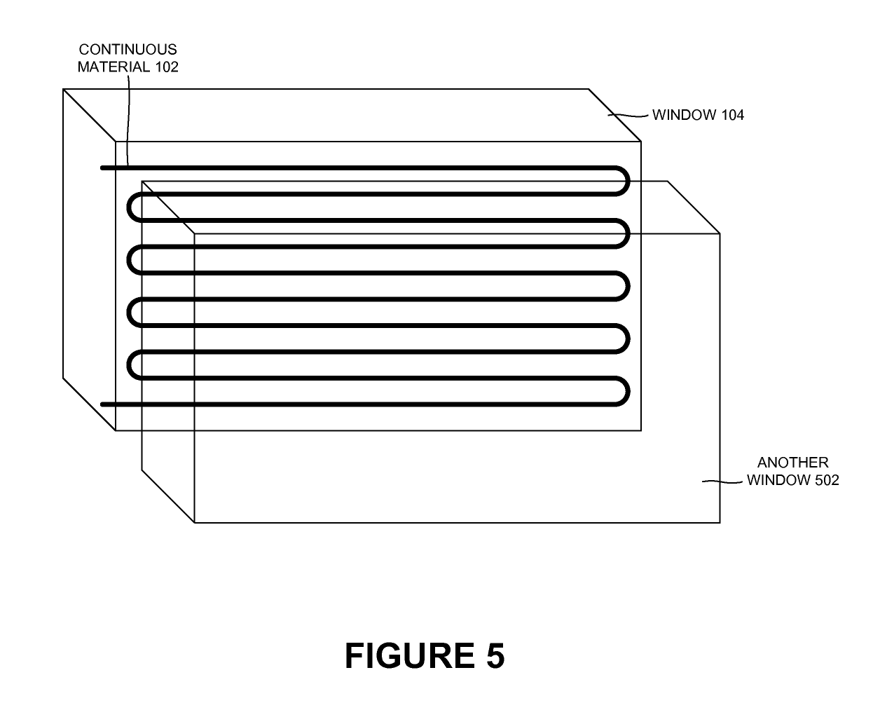

FIG. 5 is a schematic view of the apparatus of FIG. 1 including an additional window to provide safety against laser, according to one or more embodiments. In one or more embodiments, the apparatus may include a window 104 and another window 502 referred to hereafter as the second window 502. The second window 502 is included so as to increase a level of a safety. The continuous material 102 may be affixed to the window 104 and/or the second window 502. In one or more embodiments, the continuous material 102 may be affixed between the window 104 and the second window 502. In some other embodiments, the continuous material 102 may be affixed such that the window 104 and the second window 502 are adjacent to one another.

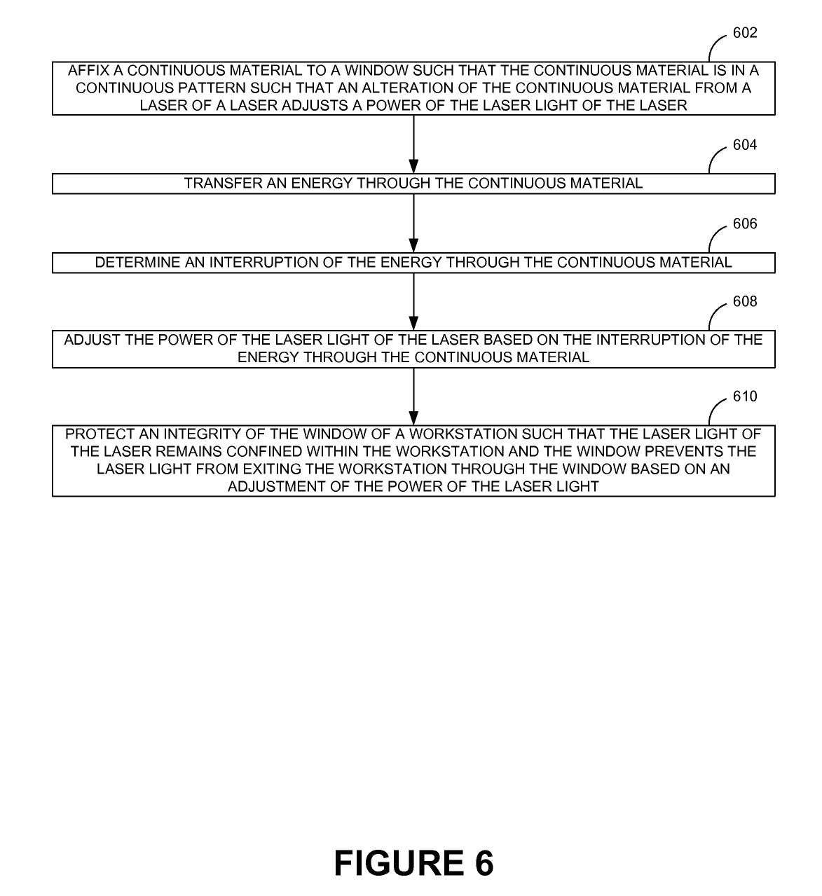

FIG. 6 shows a process flow diagram detailing the operations involved in a method of providing laser safety through a window, according to one or more embodiments. In one or more embodiments, at operation 602, a continuous material may be affixed to the window such that the continuous material is in a continuous pattern. The continuous material may be a wire. The wire may be a string of a conductive material. Examples of the conductive material includes but is not limited to platinum, silver, iron, copper, aluminum, gold, brass, bronze, conductive plastic, metal, conductive composite material, and/or semiconductor. The wire may conduct a current of electricity. The continuous material may be affixed such that an alteration of the continuous material from a laser light of a laser adjusts a power of the laser light of the laser. The alteration may cause damage to the wire to interrupt the current of the electricity through the wire.

In one or more embodiments, at operation 604, energy may be transferred through the continuous material. In one or more embodiments, at operation 606, an interruption of the energy through the continuous material may be determined. In one or more embodiments, at operation 608, the power of the laser light of the laser may be adjusted based on the interruption of the energy through the continuous material. In one or more embodiments, integrity of the window of a workstation may be protected such that the laser light of the laser remains confined within the workstation and the window prevents the laser light from exiting the workstation through the window based on an adjustment of the power of the laser light. In one or more embodiments, the integrity of the window may be protected through a stoppage of the power of the laser light. The laser light may interrupt a flow of the energy through the continuous material and may damage the continuous material. In one or more embodiments a change in a resistance and/or a temperature of the continuous material may be determined. The laser light may change the resistance of the continuous material. The power of the laser light may be stopped based on the change in the resistance of the continuous material.

In one or more embodiments a level of a safety may be increased such the continuous material is affixed to the window such that an affixation of the continuous material is either affixing the continuous material between the window and another window or affixing the continuous material such that the window and the another window are adjacent and the window is between the continuous material and the another window.

Although the present embodiments have been described with reference to specific example embodiments, it will be evident that various modifications and changes may be made to these embodiments without departing from the broader spirit and scope of the various embodiments. In addition, it will be appreciated that the various operations, processes, and methods disclosed herein may be embodied in a machine-readable medium and/or a machine accessible medium compatible with a data processing system and may be performed in any order (e.g., including using means for achieving the various operations). Accordingly, the specification and drawings are to be regarded in an illustrative rather than a restrictive sense.

What is claimed is:

1. An apparatus comprising:
a window to absorb a radiation of a laser light; and
a continuous material affixed to the window to transfer an energy through the continuous material in a continuous pattern such that an alteration of the continuous material from the laser light of a laser adjusts a power of the laser light of the laser.

2. The apparatus of claim 1:
wherein the continuous material is a wire,
wherein in the wire is a string of a conductive material,
wherein the conductive material is one of a platinum, a silver, an iron, a copper, an aluminum, a gold, a brass, a bronze, a metal, semiconductor, a conductive plastic and a conductive composite material,
wherein the wire conducts a current of an electricity, and
wherein the alteration is a damage to the wire to interrupt the current of the electricity through the wire.

3. The apparatus of claim 1:
wherein the continuous material is a conductive dry ink,
wherein the conductive dry ink conducts a current of an electricity, and
wherein the alteration is a damage to the conductive dry ink to interrupt the current of the electricity through the conductive dry ink.

4. The apparatus of claim 1:
wherein the continuous material is a conductive liquid,
wherein the conductive liquid conducts a current of an electricity, and
wherein the alteration is a damage to the conductive liquid to interrupt the current of the electricity through the conductive liquid.

5. The apparatus of claim 1:
wherein the continuous material is an optical fiber,
wherein the optical fiber comprises: a core to propagate a light beam and, a cladding to reflect the light beam back to the core, and a buffer coating to protect the core and the cladding, and
wherein the alteration is a damage to the optical fiber to interrupt a propagation of the light beam through the optical fiber.

6. The apparatus of claim 1:
wherein the continuous pattern is one of a switchback pattern, a zigzag pattern, a back-and-forth pattern, a grid pattern, and a crisscrossing pattern,
wherein the switchback pattern comprises a bend with an acute inner angle, and
wherein a distance between the continuous material before the bend and the continuous material after the bend is less than a diameter of the laser light.

7. The apparatus of claim 6:
wherein the alteration is an interruption of a transfer of the energy through the continuous material, and
wherein the interruption is from a damage to the continuous material from the laser light.

8. The apparatus of claim 7 further comprising:
a sensor to determine a change in one of a resistance and a temperature of the continuous material,
wherein the change in one of the resistance and the temperature of the continuous material indicates the alteration of the continuous material, and
wherein the power of the laser light is stopped based on the change in one of the resistance and the temperature of the continuous material.

9. The apparatus of claim 7 wherein:
the power of the laser light is reduced when the continuous material is damaged from the laser light.

10. The apparatus of claim 7 further comprising:
another window to increase a level of a safety such the continuous material is affixed to the window such that an affixation of the continuous material is one of affixing the continuous material between the window and the another window and affixing the continuous material such that the window and the another window are adjacent.

11. A system comprising:
a workstation to enclose a laser light of a laser and to protect a user from a radiation of the laser light;
a window to view the laser light of the laser inside the workstation; and
a continuous material affixed to the window to protect the window from the laser light, wherein the continuous material transfers an energy through the continuous material in a continuous pattern such that a alteration of the continuous material from the laser light of the laser adjusts a power of the laser light of the laser.

12. The system of claim 11 further comprising:
the laser to generate the laser light such that the laser and the laser light are inside the workstation.

13. The system of claim 12 wherein:
the continuous material is affixed to the window in the continuous pattern such that an affixation of the continuous material is one of attaching the continuous material to a surface of the window and embedding the continuous material within the window such that the continuous material is enclosed with the window.

14. The system of claim 13:
wherein the continuous pattern is one of a switchback pattern, a zigzag pattern, a back-and-forth pattern, a grid pattern, and a crisscrossing pattern,
wherein the switchback comprises a bend with an acute inner angle, and
wherein a distance between the continuous material before the bend and the continuous material after the bend is less than a diameter of the laser light.

15. The system of claim 14:
wherein the continuous material is a wire,
wherein in the wire is a string of a conductive material,
wherein the conductive material is one of a platinum, a silver, an iron, a copper, an aluminum, a gold, a brass, a bronze, a conductive plastic, and a semiconductor,
wherein the wire conducts a current of an electricity, and
wherein the alteration is a damage to the wire to interrupt the current of the electricity through the wire.

16. A method of comprising:
affixing a continuous material to a window such that the continuous material is in a continuous pattern such that a alteration of the continuous material from a laser light of a laser adjusts a power of the laser light of the laser;
transferring an energy through the continuous material;
determining an interruption of the energy through the continuous material;
adjusting the power of the laser light of the laser based on the interruption of the energy through the continuous material; and
protecting an integrity of the window of a workstation such that the laser light of the laser remains confined within the workstation and the window prevents the laser light from exiting the workstation through the window based on an adjustment of the power of the laser light.

17. The method of claim 16 further comprising:
protecting the integrity of the window through a stoppage of the power of the laser light,
wherein the laser light interrupts a flow of the energy through the continuous material, and
wherein the laser light damages the continuous material.

18. The method of claim 16 further comprising:
determining a change in one of a resistance and a temperature of the continuous material; and
stopping the power of the laser light based on the change in one of the resistance and the temperature of the continuous material, wherein the laser light changes one of the resistance and the temperature of the continuous material.

19. The method of claim 17:
wherein the continuous material is a wire,
wherein in the wire is a string of a conductive material,
wherein the conductive material is one of a platinum, a silver, an iron, a copper, an aluminum, a gold, a brass, a bronze, a metal, a semiconductor, a conductive plastic, and a conductive composite material,
wherein the wire conducts a current of an electricity, and
wherein the alteration is a damage to the wire to interrupt the current of the electricity through the wire.

20. The method of claim 18 further comprising:
increasing a level of a safety such the continuous material is affixed to the window such that an affixation of the continuous material is one of affixing the continuous material between the window and another window and affixing the continuous material such that the window and the another window are adjacent and the window is between the continuous material and the another window.
